(19) United States
(12) Patent Application Publication
(10) Pub. No.: US 2014/0272900 A1
(43) Pub. Date: Sep. 18, 2014

(54) Synergistic Computer-Based Testing System (SCBTS)

(71) Applicants: Joe Mellett, Cincinnati, OH (US); Mark Mellett, Lititz, PA (US)

(72) Inventors: Joe Mellett, Cincinnati, OH (US); Mark Mellett, Lititz, PA (US)

(21) Appl. No.: 14/217,389

(22) Filed: Mar. 17, 2014

Related U.S. Application Data
(60) Provisional application No. 61/798,353, filed on Mar. 15, 2013.

(51) Int. Cl. G09B 7/06

(52) U.S. Cl. CPC G09B 7/06
USPC 434/353

(57) ABSTRACT

This disclosure is drawn to methods, systems, devices and/or apparatus related to synergistic computer-based testing system. Specifically, the disclosed methods, systems, devices and/or apparatus relate to computer-based testing of one or more members of a group in a synergistic manner. In some examples, several test takers may form a group such that the group may take a test as a group. In this manner, the questions comprising the test may be completed by any test taker in the group. In some examples, some questions may be locked by a test taker such that others in the group may not provide an answer to the locked questions.

### CROSS-REFERENCE TO RELATED APPLICATIONS

This application claims priority to U.S. Provisional Patent Application Ser. No. 61/798,353, filed on Mar. 15, 2013, the contents of which are incorporated herein by reference in their entirety.

### BACKGROUND

In school, work, and other settings, a synergistic environment where people in the same group work together to achieve better results than they would have if they worked independently is encouraged. A computer-based, multi-media testing system may foster synergy and facilitate group based competition.

For example, a company may test its employees on a company-wide basis or by department, so it gives each employee a standard format multiple-choice test. The end result is a number of tests are completed and scores are tabulated for each test. Individual results are tabulated and statistics may be drawn from the submitted tests. There was no working together toward a common goal on the part of the employees. Opportunity to generate new ideas from communication about the test was lost.

Other examples may involve educational testing. An elementary school may test 30 students in 5 science classes using standard format multiple-choice exams. The result is 150 students complete 150 separate tests. In taking the test, the students didn't work together, it was every student for themselves. Similarly, a college professor may test everyone on the material so each student does their own test and an average, median or other summary score is tabulated. Again, no team effort took place in taking the tests and inevitably some students feel disappointed that their scores weren't as good as others.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a screenshot of a test administrator's account of an example synergistic computer-based testing system;

FIG. 2 is a screenshot of a test taker's account of an example synergistic computer-based testing system;

FIG. 3 is a screenshot of test results from a test taker's account of an example synergistic computer-based testing system;

FIG. 4 is a screenshot of test status and history from a test taker's account of an example synergistic computer-based testing system;

FIG. 5 is a screenshot of an example test from a test taker's account of an example synergistic computer-based testing system;

FIG. 6 is an overview of an example synergistic computer-based testing system;

FIGS. 7-8 depict a flowchart showing an example workflow of an example synergistic computer-based testing system;

FIGS. 9-15 depict a flowchart showing an example test administrator's workflow (left column) of an example synergistic computer-based testing system and corresponding example database/file system (right column) of the example synergistic computer-based testing system;

FIGS. 16-19 depict a flowchart showing an example test taker's workflow (left column) of an example synergistic computer-based testing system and corresponding example database/file system (right column) of the example synergistic computer-based testing system;

FIG. 20 depicts a comparison of conventional tests and some example tests contemplated by the SCBTS system; and

FIG. 21 is an example environment in which an example synergistic computer-based testing system may be implemented, each in accordance with at least one embodiment of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and potential points of novelty are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn to methods, systems, devices and/or apparatus related to synergistic computer-based testing system. Specifically, the disclosed methods, systems, devices and/or apparatus relate to computer-based testing of one or more members of a group in a synergistic manner.

In general, the synergistic computer-based testing system (SCBTS) may facilitate the test taking process to become a synergistic effort which produces greater learning and more creative solutions to problems that individual effort can't produce. SCBTS may educate and reinforce team building in users and may serve as an evaluation tool for test administrators. For example, test administrators may assess or evaluate traits such as knowledge base, psychological development, social skills and work skills, and the like, based on test answers and results. In the present disclosure, SCBTS may refer to methods, systems, devices and/or apparatuses, websites, portals, applications, software, services, and/or host systems associated with collaborative testing.

In some examples, SCBTS may include a test system that allows test creation, administration, taking, evaluating, and/or hosting to test the collective knowledge of one or more group. The term “group” is also used in the present disclosure. However, the present disclosure may equally apply to entities, organizations, companies, departments, business units, teams, classes, subgroups, or other groups including one or more users, for example, and these terms may be used interchangeably. The term “user,” as used in the present disclosure, may include individuals, test takers, people, team members, players, students, parents, educators, and/or employees, for example.

SCBTS may be customizable depending on the testing situation or based on a test administrator's desires or parameters. SCBTS may allow for tests to be taken collaboratively by two or more users of a group. For example, SCBTS may allow for tests to be taken remotely (e.g., via the Internet) and/or locally (e.g., via a local area network). SCBTS may allow for tests to be taken asynchronously (e.g., multiple users reading/answering questions at different times) and/or synchronously (e.g., multiple users simultaneously reading/answering questions). SCBTS may also function as an individual assessment tool for those who participate in the group, including the users themselves, a manager of the users, and/or the test administrator(s), among others. SCBTS may also function as a discussion tool, study tool, and/or training tool.

The term “psychometric”, as used in the present disclosure, relates to the theory and technique of psychological measurement, which includes the measurement of knowledge, abilities, attitudes, personality traits and educational measurement. Psychometric individual and group variables may be used for test quality of fairness, validity and reliablity; assignment of teams, etc. Other variables and data common between two or more groups and/or users can be used for quality and security and include the number of users in a group, skill variance between the users in a group, internet protocol (“IP”) addresses of group members that measure physical proximity between users of a group, the amount of data transferred per each user.

In some examples, users use their own computer devices, individually, to connect and participate on the SCBTS system, or work together at a group computer(s) in a group or as subgroups, at one or more locations. In this way, multiple computer devices may be connected to the SCBTS host system, including the test administrator and all of the users via the Internet.

In some examples, one group of users may take the same test. In some examples, more than one group may take the same test (e.g., a competition to test multiple groups with the same exact questions).

In some examples, SCBTS may allow users such as one classroom with the test projected on a wall, while an educator or team captain is entering the agreed upon answers into the system.

In some examples, every person in the world may be eligible to sign up to take a single collaborative “test of the world's knowledge,” whereby some people may sign up to participate as individuals and/or some as groups (e.g., countries, states).

In some examples, each test question may only be answered once and when the test question is selected or answered by a user, the test question may be locked out (e.g., via record lock) from another user answering and/or changing the answer. Other users may see this test question and/or answer as a grayed out item (or other designation) to signify it has been answered. FIG. 5 shows an example of this.

In some examples, each question may be answered multiple times by multiple users. This may allow for a total score greater than 100%. For example, if there are 100 questions and 5 different people answer test question number 1, then there may be a total score available of 104 out of 100 test questions.

In some examples, SCBTS may encourage team building, team spirit, collaborative work, competition, and learning. Some example applications may include:
In-house competitions for businesses and other organizations;
Departmental assessments for businesses and other organizations;
Group competitions;
College, high school, middle school, and elementary school assessment and challenges;
Contests among regional business units;
Group study activities;
Collaborative classroom games;
Research and development tool;
Emergency response fact gathering and creative solution generation;
School, college and business reward assessment systems; and/or
A test validation and quality improvement tool.

In some examples, SCBTS may also be used for public tests—the equivalent of a recreational pick-up-game—where members of the public may sign-up to be selected by those creating the tests and/or forming the groups. In this manner, SCBTS may allow a multi-user group to submit a single test that was completed by that group whereby only one overall score is generated for that group. SCBTS may also generate statistics, scores, and/or rankings for each user within a group and/or within the entirety of all users. Similarly, SCBTS may also generate statistics, scores, and/or rankings for individual topics, categories, and the like.

Test questions may be assigned in many different of ways. For example, test questions may be assigned to users randomly, by subject matter, by keyword (associated with test questions), by skill set, alphabetically, and/or by a free for all in real time using record locking, among other ways. All users may take the test during the same test period (i.e., date/time range) and/or test questions and/or test sections may be assigned sequentially from one user to the next user, building upon test sections as other users complete them.

SCBTS may provide functionalities including, test creation, test administration, test taking, test evaluation, and/or test hosting, among other functionalities. For example, SCBTS may provide:
Registration of users and/or groups;
Creation of the test in the host system;
Users joining group members remotely;
Communication among group members;
Participation in the test taking process;
Test completion and scoring;
Distribution of test results;
Test statistics (in batch and/or real time);
Record locks;
Print versions of tests;
Integration with other testing systems and test centers; and
Integration with flash cards and other test preparation and study materials and tools.

In some examples, SCBTS may be run in a “Study Mode”. A “Study Mode” may be used by users in preparation for a test where the user takes a test and receives instant prompts and explanations for the answer choices they select as they are taking the “Study Mode” test.

In some examples, SCBTS may publically and/or privately display advertising to any test administrator, group, subgroup, and/or user. Example advertising and ad revenue models may include pay per lead, CPC, PPC, CPA, contextual graphic or text ads, advertising networks, uploaded ads, and/or define bids.

In some examples, access to SCBTS may be free and/or may include a paid access model. This may include a flat fee, a subscription, and/or a freemium model, among others.

In some examples, access to SCBTS may include a paid access model for individuals and/or teams where participating individuals and/or teams may pay an amount of money to participate. The total amount of money paid in by participating individuals and/or teams is known as a “pot”. The teams may play for a money reward calculated from the “pot” and the SCBTS system owner receives a percentage of the total money paid in to the “pot”.

In some examples, a money reward may be paid in the form of a “smart payout”. A “smart payout” may be a money reward where the users of a group are rewarded money according to their performance or contribution to a test. For example, if a particular group Y wins a test competition with a money reward of $100 and group Y included 100 users that answered questions, however 25% of the correct answers were answered by user 1, then user 1 would get 25% of the money reward—$25.

Some example SCBTS workflows may include (1) creating an account, (2) creating a test, (3) creating groups, (4) taking the test, (5) scoring the test and distributing the results, and (6) security. At least a portion of this workflow 700 is represented in FIGS. 7-8. A brief overview of these aspects is discussed below.

1. Creating an Account

The test administrator may access the SCBTS system, and may review and agree to the SCBTS terms of use. In some examples, the test administrator may pay a fee to gain access to the SCBTS system. In some examples, no fee may be charged. The terms of use may include a subscription based on the amount of time for test taking, the number of tests delivered, the number of groups, number of users, and/or other parameters. The terms of use may also give the test administrator the authority to use the SCBTS system to create group tests, select groups, give authority to access the system to a defined number of users, set test rules, administer and oversee the test, access and publish test results, and any other functionality provided by the system.

The test administrator may access the SCBTS system and may create an administrative account with confidential login credentials, such as username and password. The login credentials may be changed by the test administrator. The test administrator for a given test may also be changed.

The test administrator's account in the SCBTS system may provide the test administrator the authority and functionality to create tests, create groups, assign users to groups, assign questions to groups, assign test-taking methods, set test rules, set test parameters (e.g., start and end times), receive test results, publish/distribute test results to users and/or groups, create statistics and other information from the test results. FIG. 1 is a screenshot 100 of an example test administrator's account.

In some examples, multiple levels of test administrator may be present. For example, a super administrator account may have administrative abilities to control access and/or actions of one or more test administrator.

2. Creating a Test

The test administrator may have several options to create a test using an example SCBTS system. For example, the test administrator may choose an existing test or test questions from a system library via a table of contents. menu(s) based on test categories, and/or a keyword search of the host system's database. The test administrators may also create a test by manually entering the test or test questions, and/or by uploading the test or test questions to the host system's database from the test administrator's computer or hard drive. Similarly, the test administrator may upload the test or test questions from a network (e.g., Internet). Tests organization and test question type may be created via a test interface on the SCBTS system that may allow entering questions, choosing answer options (e.g., multiple choice, essay, prioritization, true or false, fill in the blank) and any other matters, selecting a correct answer/answers, and making other settings related to the test.

The SCBTS system may offer the test administrator access to such resources such as dictionaries, thesauruses, and/or calculators to help create the tests with accuracy. The system may also have functionality to create and/or upload items to a database that may appear on the test, including graphs, tables, photographs, three-dimensional simulations, audio, video, and the like.

When the test administrator creates a new test or selects a predetermined test, the test may be saved in or otherwise linked or associated with the test administrator's account.

The test administrator may move, transfer, and/or assign the test from the test administrator's account to the test platform on the host system.

The host system may provide the test administrator multiple options to form the test parameters, including, but not limited to, open questions, questions in which any user may answer any question or only assigned questions, and/or questions in which questions are assigned exclusively to users or groups. The host system may provide the test administrator the option to have a question locked out after it is answered by a user and/or group, where the question is indicated with color marking or shading or some other annotation, to indicate that the question is no longer available to be answered by other users and/or groups.

The host system may allow the test administrator to customize the test. The test may be timed, untimed, or a combination of both. A selection may be made to show the users an opposing group's real time progress in terms of the number of questions answered, the number answered correctly, score and/or what questions are assigned to what users and/or groups.

3. Creating Groups

The test administrator may create the groups by forming group matrices in the test administrator's account.

The test administrator may assign users to the groups by entering their personal information (e.g., names, email addresses, phone numbers, other personal contact information) manually and/or by importing the personal information from popular formats like Microsoft® Excel®, Microsoft® Outlook®, Apple® iPhone®, smart phones, and the like.

The host system may have a portal on a website for users from the public to sign up to be group members. The portal may have input fields where personal identification, description, and contact information may be entered and saved. Example information may include age, education level attained, schooling, degrees, type of studies, and work experiences to show knowledge in certain fields or subject matter areas. A public list of potential group members, that may be searchable by keywords, may be published on the host system's public website. If the test administrator is making a public test, the equivalent of a “pick-up-game”, such candidates may be selected as group members.

The test administrator may enter and assign access credentials (e.g., username, password, signup URLs) to each user, and/or the host system may generate credentials for each user. Credentials may be communicated to each user by email, text, and/or other means. If signup URLs are used, they may be posted publically and/or password protected.

The test administrator may assign the role of captain to one or more users in a group. The status of captain may provide a user a different graphical user interface and additional authority that other users do not have. Some examples may include authority to assign questions to users, decision making authority in and/or for the group, authority to enter a group answer, and authority to communicate with the test administrator before, during, and/or after the test. The status of captain may also provide a user the ability to choose potential group members from a public list or a specified list to create groups for a public test, or “pick-up-game”.

The test administrator may assign one or more groups to take the test—a group may take the test by itself or against one or more other groups. When more than one group takes a test, it may be taken in real time simultaneously or at different times by each group, depending on the parameters of the test as determined by the test administrator.

The test administrator may automatically assign groups based on certain criteria, including but not limited to:
An initial assessment of some questions;
A self-questionnaire about a user's skill level;
Previous scores for a user from tests on the same test subject;
Or any combination of criteria.
The test administrator may assign groups from randomly selected users.

The test administrator may assign groups based on an organization or group that the users are a part of (e.g. a SCBTS test college competition where users who sign up for the competition with a college email address are assigned to a group with other users from the same college or used the same college email address to sign up).

Groups may be assigned by “fill in the gaps” users. “Fill in the gaps” is where the system assigns users to teams to meet the group qualification needs in order to answer the questions of a test with related qualifications. For example, if a test has a series of questions about computer networking and two groups are taking the test and two users are unassigned to groups with a qualification in computer networking, the system would “fill in the gap” by assigning the two users one to each of the groups.

Groups taking the same test may be matched up by the combined testing history of the group or by the qualifications of individuals.

Groups may also be created where the host system allows users to enter in friends or individuals that the users want to invite to be in their group from social media or online communities (e.g. Facebook, Google, Twitter). Similarly, users may request to be placed in a group that has been created or will be created by other users they are associated with.

4. Taking the Test

Users may access the host system using the assigned access credentials to access the test.

In some examples, the test may be taken on any computing device, including a desktop computer, laptop computer, tablet, a credit card terminal, a cash register, a cellular phone, and/or a smartphone, for example. The users may use their devices to take the test, interacting with the test through an input device, by voice instruction, by entering text, and/or by entering numbers. A test may be taken by users across different computing devices, for example users taking the test on a smart phone can be taking the test with other users on a laptop computer. FIG. 2 is a screenshot 200 of an example test taker's account. FIG. 3 is a screenshot 300 of test results and progress from an example test taker's account. FIG. 4 is a screenshot 400 of test status and history from an example test taker's account.

The host system may track information about a user, including a user's IP address, type of computing device, network, browser type, location, session length, actions, cookies, search, and/or other history, among other information. The host system may adapt to the type of computing device, network, browser, and/or other hardware or software in a user's computing device.

Users may use a “dibs” system where a ‘user may reserve a test question for a later time. This may reserve the question for that user and disallow other users of the group from answering that reserved question. FIG. 5 shows a screenshot 500 of an example “dibs” system. A limit may be set for the number of dibs that are utilized by any one user. Examples of “dibs” include but are not limited to questions which are in the process of being answered, question which are reserved by a user for a specific amount of time, question which are assigned to other users or groups, questions which require a minimum level of qualification that a specific user may not meet, questions which would take a user over a quota for a specific type of questions.

In some examples, users can view synergistic notes and synergistic attachments during a test or while answering a question. Synergistic notes and attachments provide users in the same group to be able to type, speak, or video record into a notes field that is attached to a question or a question bank. The synergistic notes may be automatically dated and sorted by most recent first. A user may view information regarding the synergistic note including but not limited to the date, time, user who created the synergistic note, and the synergistic note itself. A synergistic attachment may be any supported file (e.g. image, video, audio, text, spreadsheet) that a user can attach as supporting material to solve a question.

Users may communicate with each other and/or the test administrator via email, text message, message board, chat board, phone or video conferencing, visual arts tools, drawing boards, and/or image and video uploads, on the host system. The host system may provide a checking off system (e.g., “select all”) to send a custom form message to others, with text, audio, and/or video information depending on the medium of the message. The host system may also provide the ability to transmit status message notifying users that the test has started, that the test has ended, and/or a summary score report by each user and/or group, among other status messages.

Users may answer questions using question voting. Users question vote by providing their percentage of degree of certainty that a certain answer is correct and the host platform will automatically tabulate the percentage of degree of certainty of the available answers and choose which answer has the highest degree of certainty among the participating users.

Users may also participate in synergistic partial answering or voting of multiple choice questions. Users may answer multiple choice questions where the users do not know the correct answer but know that one or more answers are incorrect by indicating the answers the users believe are incorrect. The host system may record the selections and may make the incorrect selections viewable by other users within the group.

The test administrator may be able to track all groups' progress in real time by toggling between test administration and test taking/progress screens. The test administrator may field questions from any user or the captain, depending on what parameters the test administrator set. The test administrator may pause and/or restart the test for any reason. The test administrator may also proctor the test.

Depending on the test administrator's selection, the host platform may assign questions to particular users randomly or by weighted factors such as age, schooling, degree, experience, education, gender, and/or location, among other factors. Such assignment may be carried out by an algorithm using information input to the host system by the test administrator or the user.

In some examples, a test competition may be held between test taking groups. In the example for a test competition, the distribution of test results may be staggered by sending results to the winning group first so that the winning group has an advantage in preparing for the next phase of the test competition.

Users within the same group may utilize a test staging system. A test staging system works by prompting, tracking, or reporting to users various stages of a test. Examples of stages of a test include but are not limited to registration; receiving a test outline; receiving test samples; user collaboration through email chat, video, phone, or other collaborative method; start of a test; that a test is in progress; completion of a test; when final scores and reports are generated; and the distribution of final results.

The host system may allow test mentors to register for one or more groups taking a test. A test mentor may have the ability to add or update Synergistic Notes and Attachment but will not have the ability to answer questions. A test mentor may also have the ability to, but are not limited to, chat, video conference, email and perform other communications with users.

5. Scoring the Test

When a test is completed, a score and/or scores will be determined and/or calculated. Example scores may include a group score, a subgroup score, and/or individual user scores. These scores may be based on many factors such as the number of questions answered correctly and answered incorrectly, and they may include percentages, averages, means, weighting, rankings, and other measurements. There may also be scoring based on the collaborative effort, measuring the communication among the users and the amount of distributed activity among the users. In some examples, a history of test scores may be stored on a per user and/or per group basis.

To make for closer competition between groups with varying abilities, a handicapping option may be available. The handicapping option provides advantages to groups with users below a specified standard or provides disadvantages to groups with users above a specified standard. For example, a handicap may give points to users with qualifications below a qualification standard that are added to the total raw score of a test from which a final percentage can be calculated. Additionally, another example of a handicap may take points from users with qualifications above a qualification standard that are subtracted from the total raw score from which a final percentage can be calculated.

The test administrator may run reports and/or compile statistics by user, subgroup, and/or group.

The host system may offer various posting and distribution options.

The host system may have several posting options, including a code generator that may allow the creation and posting of the test results on another website or web page, such as social networks.

The host system may offer social testing where virtual introductions are made between users of common skill, common scoring, or some other variable that the two users have in common. For example, a user Y and a user Z scored at least 10% better than any other users on a test. The host system emails both users a message and asks if users Y and Z want to connect.

The host system may provide a Group Collaboration Score (GCS). The group collaboration score may be a measurement unique score based on the following equation: GCS)=number of unique collaborative communications/number of users in the same testing group. In some examples, one variable for the number of unique collaborative communication is the amount of data transfer between group members.

The host system may provide a Group Quality Score (GQS). The Group Quality Score may be a score that applies psychometric principals and standards to measure the validity, reliability, and fairness of groups as a whole as opposed to individuals. The equation for GQS is GQS=(A+B+C+ . . . )/Y where (A+B+C+ . . . ) is the sum of the psychometric measurements in question for users of a group and Y is the total number of users in a group.

The host system may perform synergistic value measurements. A synergistic value measurement may be the comparison of the results of a test when taken by a group and the results of a test when taken individually by a user of that group. The synergistic value measurement may evaluate the improvement or decline in scores and knowledge of individual users or groups as a whole in the taking of a test as a synergistic group versus as an individual user. For example, a teacher may give a test to individual users who are students of a class. Then, the teacher may give the test to a class as a synergistic group with only one score. Afterwards, the scores of the individual users may be compared with the score of the synergistic group to provide a synergistic value measurement.

6. Security

The host platform may track security issues. Administrators may be able to set security preferences, including analyze test results for security breaches. In some examples, a total security score may be calculated and recorded for a test as a whole or for specific groups taking a certain test.

Test administrators may have the ability to set security preferences such as the number of security issues a group and/or an individual can have in total before they are disqualified.

In some examples, when a user within a group is found to have a security issue—for example, receives a number of security issues more than the security preference set by the test administrator for the number of security issues for disqualification—the user may be withdrawn from the test and the questions the user answered may be returned to the unanswered set of questions for the group.

In some examples, automatic online proctoring via a webcam may be an optional setting for the security of a test or tests.

In some examples, the host system may detect if the same user's account is being accessed at the same time simultaneously. The host system may note the access and notify participants, including but not limited to the test administrator, any team captain, any group, any user, or the specific user who's account is being accessed.

FIGS. 9-15 depict a chart 900 showing an example test administrator's workflow (left column) and corresponding example database/file structure (right column). The present disclosure contemplates that some example workflows may incorporate some or all of the operations and structures shown in FIG. 9-15.

FIGS. 16-19 depict a chart 1600 showing an example test taker's workflow (left column) and corresponding example database/file structure (right column). The present disclosure contemplates that some example workflows may incorporate some or all of the operations and structures shown in FIG. 16-19.

FIG. 20 depicts a comparison 2000 of conventional tests and some example tests contemplated by the SCBTS system, in accordance to at least some examples of the present disclosure. The conventional tests have many test takers each taking their own test. SCBTS example systems allow many test takers to take one test. In some examples, the SCBTS system may use a ratio of an unlimited number of test takers to the same single scored test so that only one test score is the result. This score may measure the group of test takers as a whole against individuals within the group.

FIG. 21 illustrates an exemplary environment 2100 for implementing and/or controlling various aspects of an example system that includes a computing device such as computer 1602, the computer 1602 including a processing unit 1604, a system memory 1606 and a system bus 1608. The system bus 1608 couples system components including, but not limited to, the system memory 1606 to the processing unit 1604. The processing unit 1604 may be any of various commercially available processors. Dual microprocessors and other multi-processor architectures may also be employed as the processing unit 1604.

The system bus 1608 may be any of several types of bus structure that may further interconnect to a memory bus (with or without a memory controller), a peripheral bus, and a local bus using any of a variety of commercially available bus architectures. The system memory 1606 includes read only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 may also include a high-speed RAM such as static RAM for caching data.

The computer 1602 may further include an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 may be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of an example system.

A number of program modules may be stored in the drives and RAM 1612, including an operating system 1630, one or more application programs 1632, other program modules 1634 and program data 1636. All or portions of the operating system, applications, modules, and/or data may also be cached in the RAM 1612. It is appreciated that an example system may be implemented with various commercially available operating systems or combinations of operating systems. In some examples, example systems and methods may include and/or operate on a non-transitory computer-readable medium.

A user may enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but may be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 may be a workstation, a server computer, a router, a personal computer, portable computer, microprocessor-based entertainment appliance, a peer device or other common network node, and typically includes many or all of the elements described relative to the computer 1602, although, for purposes of brevity, only a memory storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 may include a modem 1658, or is connected to a communications server on the WAN 1654, or has other means for establishing communications over the WAN 1654, such as by way of the Internet. The modem 1658, which may be internal or external and a wired or wireless device, is connected to the system bus 1608 via the serial port interface 1642. In a networked environment, program modules depicted relative to the computer 1602, or portions thereof, may be stored in the remote memory/storage device 1650. It will be appreciated that the network connections shown are exemplary and other means of establishing a communications link between the computers may be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth wireless technologies. Thus, the communication may be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, n, etc.) to provide secure, reliable, fast wireless connectivity. A Wi-Fi network may be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks may provide real-world performance similar to the basic 10BaseT wired Ethernet networks used in many offices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
defining a group comprising a first user and a second user;
selecting a test to be completed by the group, the test including a plurality of questions;
assigning the test to the group for completion;
receiving responses to the plurality of questions from the first user and the second user;
comparing the responses to correct answers for the plurality of questions; and
generating at least of a group score, a first user score, and a second user score.

2. The method of claim 1, wherein selecting a test to be completed by the group comprises at least one of creating the test and selecting the test from a plurality of pre-generated tests.

3. The method of claim 2, wherein creating the test comprises:
receiving a plurality of test parameters for determining a format and rules for the test; and
generating the test in accordance with the test parameters.

4. The method of claim 1, further comprising:
creating a first account associated with the first user;
creating a second account associated with the second user; and
associating at least one of the group score and the first user score with the first account; and
associating at least one of the group score and the second user score with the second account.

5. The method of claim 1, wherein receiving responses to the plurality of questions from the first user and the second user comprises receiving a portion of the responses from the first and receiving a portion of the responses from the second user.

6. The method of claim 1,
wherein the plurality of questions comprises a first question and a second question; and
wherein receiving responses to the plurality of questions from the first user and the second user comprises:
receiving a first response to the first question from the first user; and
receiving a second response to the second question from the second user.

7. The method of claim 6, further comprising:
restricting the second user from providing a first response to the first question.

8. The method of claim 1, further comprising comparing the group score against a plurality of other groups.

9. A method, comprising:
receiving a group assignment associating a first test taker with a group including at least a second test taker;
receiving a test assignment for the group, the test assignment identifying a test to be completed by the group, the test including at least a first question and a second question;
completing the test by providing at least a first response to at least the first question;
receiving at least one of a group score including a number of correct responses by the group, a first test taker score including a number of correct responses by the first test taker, and a second test taker score including a number of correct responses by the second test taker.

10. The method of claim 9, further comprising:
placing a hold on the first question such that only the first test taker may provide the first response to the first question.

11. The method of claim 9, further comprising:
prior to receiving a group assignment, requesting access to join the group.

12. The method of claim 9, further comprising:
communicating with the second test taker during completing the test.

13. A method, comprising:
creating a user account for each user of a group;
generating a test to be completed by the group, the test including a plurality of questions;
providing access to the test to the group;
receiving a plurality of responses for each of the plurality of questions;
comparing the plurality of responses with a respective correct answer for each of the plurality of questions;
generating a group score representing a correctness of the plurality of responses; and
generating a user score for each of the plurality of users, each respective user score representing a correctness of the plurality of responses provided by each user.

14. The method of claim 13, wherein the group comprises at least one of an entity, an organization, company, a department, a business unit, a team, a school, a class, and a subgroup.

15. The method of claim 13, wherein each user comprises at least one of an individual, a test taker, a person, a team member, a player, a student, a parent, an educator, and/or an employee.

16. The method of claim 13, wherein receiving a plurality of responses for each of the plurality of questions occurs at least one of asynchronously and synchronously.

17. The method of claim 13, further comprising:
assigning a captain role to at least one of the users in the group to create a captain user in the group, wherein the captain user may assign at least a portion of the plurality questions among the users.

18. The method of claim 13, wherein providing access to the test to the group includes access for a pre-determined time period.

19. The method of claim 13, further comprising:
storing information about at least one of the user's activities while the test is accessible to the group.

20. The method of claim 13, further comprising:
ranking the group score against a score of a third party group.
